(19) United States
(12) Patent Application Publication
(10) Pub. No.: US 2011/0072168 A1
(43) Pub. Date: Mar. 24, 2011

(54) DATA TRANSFER SYSTEM WITH DIFFERENT OPERATING MODES

(76) Inventors: Hongxiao ZHAO, Wuhan (CN); Yonghua GOU, Wuhan (CN); Xiaoguang YU, Wuhan (CN)

(21) Appl. No.: 12/565,874

(22) Filed: Sep. 24, 2009

(51) Int. Cl. G06F 3/00; G06F 13/00; G06F 12/00

(52) U.S. Cl. 710/14; 710/74; 711/103; 711/E12.001; 711/E12.008

(57) ABSTRACT

An electronic system includes an input/output (I/O) interface and a controller coupled to the I/O interface and a storage medium. The controller can select an operating mode from multiple operating modes based on a type of the storage medium. At least two of the operating modes have different data transfer rates. The controller can operate in the selected operating mode to transfer data between the I/O interface and the storage medium according to a data transfer rate of the selected operating mode.

### BACKGROUND

A CompactFlash (CF) card is a mass storage device that conforms to the CompactFlash standard. The CompactFlash Association (CFA) developed the CompactFlash standard and subsequently published CompactFlash+ specification (CF+) and CompactFlash Specification Revision 4.0 (CF4). The earlier type of CF cards utilizes common memory data storages. Currently, CF+ and CF4 cards are expanded to include input/output (I/O) devices or magnetic disk data storages, depending on specific applications. The CF+ and CF4 cards support a higher data transfer rate than the earlier type of CF cards.

The earlier type of CF cards may only operate in the PC Card ATA (Advanced Technology Attachment) using memory mode. CF4 and CF+ cards can operate in the PCMCIA (Personal Computer Memory Card International Association) mode which includes the PC Card ATA using I/O mode and the PC Card ATA using memory mode. Moreover, the CF4 cards can operate in the True IDE (integrated development environment) mode and the CF+ cards may also function in the True IDE mode. In each mode, data is transferred according to a corresponding read/write timing cycle. Therefore, CF, CF+ and CF4 cards operating in different modes may have different data transfer rates.

Typically, a controller is used to control data transfer between a host (e.g., a computer) and a storage device. The controller is usually set in a predetermined mode to communicate with the storage device according to a predetermined data transfer rate. However, as CF, CF+ and CF4 cards may support different data transfer rates, the data transfer performance may be reduced. For example, if the controller is set in the PC Card ATA using memory mode, a CF+/CF4 card operating in the PC Card ATA using memory mode may have a lower data transfer rate compared to the CF+/CF4 card operating in the True IDE mode.

### SUMMARY

In one embodiment, an electronic system includes an input/output (I/O) interface and a controller coupled to the I/O interface and a storage medium. The controller can select an operating mode from multiple operating modes based on a type of the storage medium. At least two of the operating modes have different data transfer rates. The controller can operate in the selected operating mode to transfer data between the I/O interface and the storage medium according to a data transfer rate of the selected operating mode.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 shows a data transfer system with multiple operating modes according to one embodiment of the present invention.

FIG. 2 shows a data transfer system with multiple operating modes according to another embodiment of the present invention.

FIG. 3 shows a data transfer system with multiple operating modes according to another embodiment of the present invention.

FIG. 4 is a flowchart of a method for controlling data transfer according to one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “detecting,” “selecting,” “enabling,” “transferring,” “setting” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments in accordance with the present invention provide data transfer systems with multiple operating modes. A controller in the system can operate in multiple operating modes to control the data transfer between a host and a client, e.g., a storage medium. Advantageously, the controller can select an operating mode from multiple operating modes based on a type of the storage medium, and operate in the selected operating mode to communicate with the storage medium according to a corresponding data transfer rate in the selected operating mode. Furthermore, the selected operating mode can include multiple sub-modes. The controller can select an operating sub-mode from multiple sub-modes based on a predetermined operation standard. As a result, the data transfer performance between the host and the storage medium can be improved.

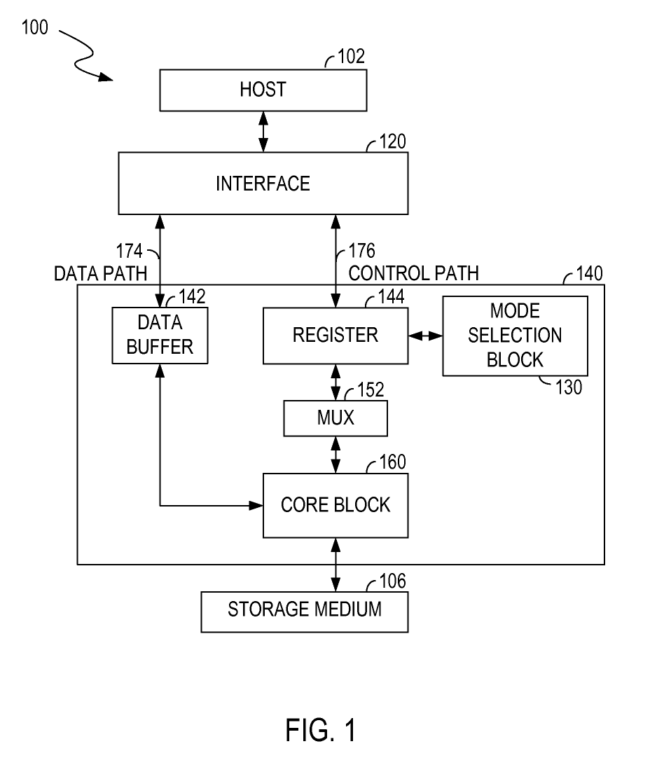

FIG. 1 shows a data transfer system 100 according to one embodiment of the present invention. In the example of FIG. 1, the data transfer system 100 includes a host 102, an interface 120, a controller 140, and a client. In one embodiment, the client includes a storage medium 106. The storage medium 106 can be, but is not limited to, a CF+ card or a CF4 card. The controller 140 and the interface 120 transfer data between the host 102 and the storage medium 106. The interface 120 can be, but is not limited to, a peripheral component interconnect (PCI) interface, a PCI extended (PCI-X) interface, or a PCI express (PCIe) interface. The host 102 can be an electronic device or system, such as a computer, a personal digital assistance (PDA), a mobile phone, or the like. The host 102 can read data from the storage medium 106 or write data into the storage medium 106.

The interface 120 can serve as an I/O (input/output) interconnect between the host 102 and the controller 140. The information transferred between the host 102 and the controller 140 can include data information and control information. In one embodiment, the host 102 operates as a master to initiate a data transfer. In this instance, the host can send the control information to the controller 140. The control information can enable the hand-shake between the host 102 and the controller 140 before the data information is transferred. The control information can define a characteristic of the data transfer, for example, whether the data is written into the storage medium 106 or read out from the storage medium 106. For example, the data information can be transferred from the host 102 to the controller 140 in a write operation, and the data information can be transferred from the controller 140 to the host 102 in a read operation. The control information can also indicate a status of the data transfer, for example, start/initiation of the data transfer. In another embodiment, the storage medium 106 can operate as a master to initiate a data transfer. In this instance, the storage medium can send the control information to the controller 140.

In one embodiment, the interface 120 can analyze the information transferred from the host 102 to determine if the host 102 transfers data information or control information. The interface 120 can selectively transfer the information through a data path 174 or a control path 176 depending on whether the host 102 transfers the data information or the control information. If the host transfers the data information, the data can be sent to the controller 140 through the data path 174. If the host 102 transfers the control information, the control information can be sent to the controller 140 through the control path 176. Moreover, the interface 120 can packet the data information from the controller 140 into data readable by the host 102 (computer-readable data) and transfer the data to the host 102.

The controller 140 can transfer the data information between the interface 120 and the storage medium 106. Advantageously, the controller 140 coupled between the interface 120 and the storage medium 106 can operate in multiple operating modes to control the data transfer between the host 102 and the storage medium 106. In one embodiment, at least two of the operating modes have different data read/write timing cycles. A read cycle is the time needed between the start of a read operation and the start of the next read cycle. Similarly, a write cycle is the time needed between the start of a write operation and the start of the next write cycle. Therefore, at least two of the operating modes have different data transfer rates. In one embodiment, the multiple modes include, but are not limited to, a PCMCIA mode and a True IDE mode. In the PCMCIA mode, the data is transferred according to a corresponding write/read timing of the PCMCIA standard. In the True IDE mode, the data is transferred according to a corresponding write/read timing of the True IDE standard.

Advantageously, the controller 140 can select an operating mode from the multiple operating modes based on a type of the storage medium 106. Since different types of the storage medium 106 may support different data transfer modes, the controller 140 can transfer data between the host 102 and the storage medium 106 in a mode that is compatible with the storage medium 106. For example, if the storage medium 106 is a CF+ or CF4 card, the controller 140 can select the PCMCIA mode or True IDE mode as the operating mode. In other words, the controller 140 can be a universal controller and can select a proper operating mode according to the type of the storage medium 106. The controller 140 can operate in the selected operating mode to enable the data transfer between the I/O interface 120 and the storage medium 106 according to a corresponding data read/write timing cycle and a corresponding data transfer rate of the selected operating mode. In one embodiment, if more than one mode in the multiple operating modes are compatible with the storage medium 106, the controller 140 can select a mode that provides desired data transfer performance, e.g., relatively high data transfer rate, as the operating mode.

Moreover, in one embodiment, the operating mode selected by the controller 140 can include multiple sub-modes. The controller 140 can select an operating sub-mode from the multiple sub-modes based on a predetermined operation standard. For example, the PCMCIA mode can include multiple sub-modes, such as a PC card ATA using I/O mode and a PC card ATA using memory mode. When the controller 140 operates in the PC card ATA using I/O mode or a PC card ATA using memory mode, the storage medium 106 uses different signals to communicate with the controller 140. For example, when the storage medium 106 is a CF+ or CF4 card and when the controller 140 operates in the PC card ATA using I/O mode, the storage medium 106 uses signals at the pins 34 and 35 of the storage medium 106 to communicate with the controller 140. In one embodiment, the controller 140 uses the signal IORD at the pin 34 to read data from the storage medium 106, and uses the signal IOWR at the pin 35 to write data from the host 102 into the storage medium 106. However, when the controller 140 operates in the PC card ATA using memory mode, the storage medium 106 does not use the signals at the pins 34 and 35, in one embodiment. By way of example, when the storage medium 106 is a CF+ or CF4 card and when the controller 140 operates in the PC card ATA using memory mode, the storage medium 106 uses signals at the pins 9 and 36 of the storage medium 106 to communicate with the controller 140. In one embodiment, the controller 140 uses the signal OE at the pin 9 to read data from the storage medium 106, and uses the signal WE at the pin 36 to write data from the host 102 into the storage medium 106. However, when the controller 140 operates in the PC card ATA using I/O mode, the controller 140 uses the signal OE at the pin 9 to read data from configuration registers of the storage medium 106, and uses the signal WE at the pin 36 to write data into the configuration registers in the storage medium 106.

The True IDE mode can include multiple sub-modes, such as a primary I/O (PIO) mode, a multiword direct memory access (MDMA) mode, and an ultra direct memory access (UDMA) mode. By way of example, when the storage medium 106 is a CF+ or CF4 card and when the controller 140 operates in the PIO mode, there is an interrupt after a predetermined length of data, e.g., 512 bit of data, is transferred from the host 102 to the storage medium 106. When the controller 140 operates in the MDMA mode, all the data can be transferred from the host 102 to the storage medium 106 at one time without any interrupt. When the controller 140 operates in the UDMA mode, the storage medium 106 can operate as a master, e.g., the storage medium 106 can initiate a data transfer from the storage medium 106 to the host 102. In this embodiment, the storage medium 106 can send control information, e.g, a DMA request, to the controller 140 to initiate the data transfer. The PIO mode can further include multiple PIO modes. The multiple PIO modes may have different read/write timing cycles. Similarly, the MDMA mode can further include multiple MDMA modes. The multiple MDMA modes may have different read/write timing cycles. The UDMA mode can further include multiple UDMA modes. The multiple UDMA modes may also have different read/write timing cycles. The controller 140 can select an operating sub-mode from the multiple sub-modes based on a predetermined operation standard.

In one embodiment, the predetermined operation standard is a data transfer rate standard. The controller 140 selects an operating sub-mode to obtain a desired data transfer rate, e.g., a relatively high data transfer rate, of the data transfer between the I/O interface 120 and the storage medium 106. In another embodiment, the predetermined operation standard is a priority standard. The controller 140 can determine a priority of the data transfer request and selects an operating sub-mode according to the priority of a data transfer request of a data transfer between the I/O interface 120 and the storage medium 106. For example, in the data transfer system 100, the request for the data transfer between the host 102 and the storage medium 106 may coexist with other requests such as an interrupt request. If the priority of the request for the data transfer between the host 102 and the storage medium 106 is relatively high, the mode selection block 130 can select an operating sub-mode that supports a relatively high data transfer rate. If the priority of the request for the data transfer between the host 102 and the storage medium 106 is relatively low, the mode selection block 130 can select an operating sub-mode that supports a relatively low data transfer rate. In one embodiment, the mode-select block 130 executes a computer-executable program to select the operating mode and/or the sub-mode.

In the example of FIG. 1, the controller 140 includes a data buffer 142, a register 144, a mode selection block 130, a multiplexer (MUX) 152, and a core block 160. The data buffer 142 can buffer the data information from the interface 120 and provide the data information to the core block 160. The data buffer 142 can also buffer the data information from the core block 160 and provide the data information to the interface 120. The register 144 can store the control information received from the interface 120 when the host 102 operates as a master or from the storage medium 106 when the storage medium 106 operates as a master, and can store mode data indicative of the multiple operating modes and sub-modes in which the controller 140 can operate. The mode data can be accessed by the mode selection block 130 to select the operating mode and/or sub-mode for the controller 140. In one embodiment, the register 144 also stores data which indicates if the data transfer is completed and which can be accessed by the host 102. In this instance, the core block 160 can generate the data indicative of the completion of the data transfer. In another embodiment, the host 102 can determine if the data transfer is completed by itself.

The core block 160 is coupled to the data buffer 142 and can include multiple cores. Each core can operate in a corresponding mode to communicate with the storage medium 106. In one embodiment, a core can be a micro-controller and can generate signals (e.g., read/write signal) according to the read/write timing of a corresponding mode to enable a data transfer process. The storage medium 106 receives the signals generated by the core and responses accordingly. For example, if the host 102 initiates a data transfer to write data into the storage medium 106, the corresponding core can generate a write signal according to the control information from the host 102. In response, the storage medium 106 receives the data information transferred from the host 102. If the host 102 initiates a data transfer to read data from the storage medium 106, the corresponding core can generate a read signal according to the control information from the host 102. In response, the storage medium 106 transfers/provides the data information to the host 102. In one embodiment, if an operating mode is selected, a corresponding core can be enabled according to the selected operating mode to communicate with the storage medium 106. The data can be transferred between the host 102 and the storage medium 106 via the enabled core.

In one embodiment, before any operating mode is selected by the mode selection block 130, the controller 140 operates in a default mode and a default core that can operate in the default mode is used to communicate with the storage medium 106.

The mode selection block 130 can select an operating mode from the multiple operating modes based on the type of the storage medium 106 and select an operating sub-mode from the multiple sub-modes based on a predetermined operation standard. More specifically, the mode selection block 130 can access the mode data stored in the register 144 indicative of multiple modes and sub-modes in which the controller 140 can operate. The mode selection block 130 can detect the type of the storage medium 106 and the mode(s) supported by the storage medium 106. In one embodiment, the mode selection block 130 can send an identification command to the register 144 to request identity information of the storage medium 106. Data indicating the identification command can be written into the register 144. The default core in the core block 160 can monitor the register 144 and can generate a signal requesting identity information of the storage medium 106 accordingly. In response, the storage medium 106 can send data indicative of the type of the storage medium 106 and the mode(s) supported by the storage medium 106 to the register 144 via the default core. Thus, the mode selection block 130 can access the identity information of the storage medium 106 in the register 144. The mode selection block 130 selects an operating mode which is compatible with the storage medium 106 from the multiple modes. In one embodiment, if more than one mode in the multiple modes are compatible with the storage medium 106, the mode selection block 130 can select a mode that provides desired data transfer performance, e.g., relatively high data transfer rate, as the operating mode. If the selected operating mode includes multiple sub-modes, the mode selection block 130 can further select an operating sub-mode according to the predetermined operation standard from the corresponding multiple sub-modes.

Once the operating mode is selected, the mode selection block 130 can configure the controller 140 to operate in the selected operating mode or sub-mode. In one embodiment, the mode selection block 130 configures the controller 140 by writing the corresponding mode data indicative of the selected operating mode and/or sub-mode into the register 144.

The multiplexer 152 is coupled to the register 144 and the core block 160 for enabling one of the cores according to the mode data indicative of the selected operating mode and/or sub-mode in the register 144. Consequently, the enabled core can communicate with the storage medium 106, for example, to transfer the data information to the storage medium 106, according to the data transfer rate in the selected operating mode and/or sub-mode.

An operation example of transferring data from the host 102 to the storage medium 106 is described here. In one embodiment, the host 102 first transfers control information to the controller 140 through the interface 120 and the control path 176 to initiate a data transfer from the host 102 to the storage medium 106. When the register 144 receives the control information, the mode selection block 130 can be enabled to select an operating mode. The mode selection block 130 can select the operating mode and can further select an operating sub-mode. Thus, the mode selection block 130 can set the controller 140 in the selected operating mode and the selected operating sub-mode. According to the operating mode and the operating sub-mode selected by the mode selection block 130, the multiplexer 152 can enable one of the cores in the core block 160 to communicate with the storage medium 106. The host 102 transfers the data information to the data buffer 142 through the interface 120 and the data path 174. The data buffer 142 can provide the data information to enabled core in the core block 160. As such, the data information can be sent to the storage medium 106. The host 102 can access the register 144 to determine if the data transfer is completed, in one embodiment.

An operation example of transferring data from the storage medium 106 to the host 102 is described here. In one embodiment, the host 102 first sends control information to the controller 140 through the interface 120 and the control path 176 to request a data transfer from the storage medium 106 to the host 102. After the controller 140 is set in the selected operating mode and the selected operating sub-mode by the mode selection block 130, the multiplexer 152 can enable one of the cores in the core block 160 to communicate with the storage medium 106. As such, the data can be transferred from the storage medium 106 to the core block 160. Through the data buffer 142, the data path 174, and the interface 120, the data can be sent to the host 102. The host 102 can access the register 144 to determine if the data transfer is completed, in one embodiment.

As described above, the host 102 operates as a master to initiate a data transfer. In another embodiment, the storage medium 106 can operate as a master to initiate a data transfer. In this embodiment, the mode selection block 130 can be first enabled by the host 102 to select an operating mode. By way of example, when the storage medium 106 is a CF+ or CF4 card, the mode selection block 130 selects the True IDE mode as the operating mode and further selects the UDMA mode as the operating sub-mode. Thus, the mode selection block 130 sets the controller 140 in the UDMA mode. The multiplexer 152 enables a core in the core block 160 that can operate in the UDMA mode to communicate with the storage medium 106. In the UDMA mode, the storage medium 106 operates as a master to initiate a data transfer between the storage medium 106 and the host 102.

More specifically, the storage medium 106 sends control information to the controller 140 to initiate a data transfer, in one embodiment. The enabled core in the core block 160 can analyze the information transferred from the storage medium 106 to determine if the storage medium 106 transfers data information or control information. If the storage medium 106 transfers the control information, the core block 160 can analyze the control information to determine whether the storage medium 106 initiates a read operation (read data from the host 102) or a write operation (write data into the host 102). If the storage medium 106 transfers the data information, the controller 140 can transfer the data information through the data path 142. If the storage medium 106 initiates a data transfer to write data into the host 102, the enabled core can generate a read signal according to the control information from the storage medium 106. In response, the host 102 receives the data information transferred from the storage medium 106 via the data path 174. If the storage medium 106 initiates a data transfer to read data from the host 102, the enabled core can generate a write signal according to the control information from the storage medium 106. In response, the host 102 transfers/provides the data information to the storage medium 106 via the data path 174.

Therefore, the controller 140 can select an operating mode based on the type of the storage medium 106. Furthermore, the controller 140 can select an operating sub-mode according to a predetermined operation standard. Advantageously, the controller 140 can provide data transfer control adapted to various storage medium 106 and in accordance with various operation standards.

In one embodiment, before the storage medium 106 is coupled to the controller 140, the controller 140 can be set in a default operating mode. In one embodiment, the default mode can be a mode that supports a relatively high data transfer rate. After the storage medium 106 is coupled to the controller 140, the mode selection block 130 can determine if the default mode is compatible with the storage medium 106. If the default mode is compatible with the storage medium 106, the controller 140 can operate in the default mode to communicate with the storage medium 106. Thus, higher data transfer performance can be achieved. If the default mode is not compatible with the storage medium 106, the mode selection block 130 can select another mode.

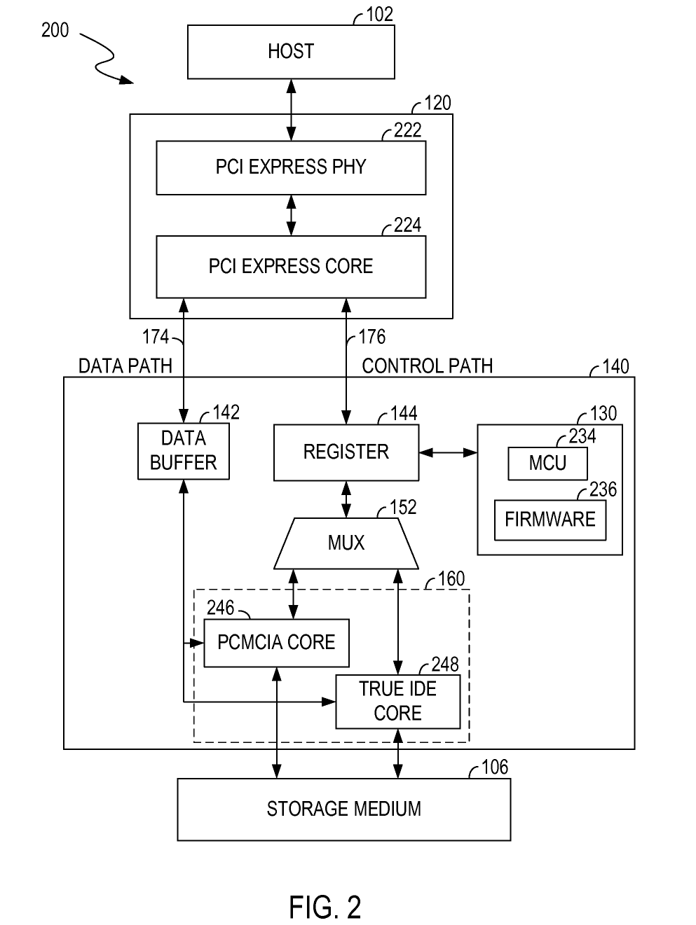

FIG. 2 shows a data transfer system 200 according to one embodiment of the present invention. Elements labeled the same as in FIG. 1 have similar functions. In the example of FIG. 2, the data transfer system 200 includes the host 102, the PCIe interface 120, the controller 140, and the storage medium 106. The storage medium 106 can be, but is not limited to, a CF+ card or a CF4 card. The controller 140 and the PCIe interface 120 can transfer data between the host 102 and the storage medium 106.

The PCIe interface 120 serves as an I/O interconnect to transfer data between the host 102 and the controller 140. The Peripheral Component Interconnect Express (PCIe) is a computer interconnect standard having a relatively high speed data transfer rate. For example, a PCIe link is able to support up to 32 lanes and provide an effective 2.5 Gigabits/second/Lane/direction of raw bandwidth. Thus, the PCIe provides higher performance than the PCI and PCI-X. In addition, the PCIe supports the Hot-Plug/Hot-Swap. In the embodiment of FIG. 2, the PCIe interface 120 includes a PCIe physical layer (PHY) 222 and a PCIe core 224. If the host 102 sends serial data to the PCIe interface 120, the PCIe PHY 222 can transform the serial data into parallel data and provide the parallel data to the PCIe core 224. The PCIe core 224 can analyze the parallel data to determine whether the information sent from the host 102 is data information or control information. The PCIe core 224 transfers the data information to the controller 140 through the data path 174 and transfers the control information to the controller 140 through the control path 176. As such, the information from the host 102 can be sent to the controller 140 via the PCIe interface 120.

Similarly, if the controller 140 transfers the data information to the PCIe interface 120, the PCIe core 224 can packet the data information to provide the parallel data to the PCIe PHY 222. The PCIe PHY 222 can transform the parallel data into the serial data and send the serial data to the host 102. As such, the PCIe interface 120 can transfer the data information to the host 102.

The controller 140 can communicate with the storage medium 106 to transfer data between the PCIe interface 120 and the storage medium 106. In the example of FIG. 2, the controller 140 includes the data buffer 142, the register 144, the mode selection block 130, the multiplexer 152, and the core block 160. In one embodiment, the core block 160 includes a PCMCIA core 246 and a True IDE core 248. The PCMCIA core 246 can operate in the PCMCIA mode. The True IDE core 248 can operate in the True IDE mode.

The mode selection block 130 can select an operating mode according to the type of the storage medium 106 from the PCMCIA mode and the True IDE mode. Furthermore, if the selected operating mode includes multiple sub-modes, the mode selection block 130 can select an operating sub-mode according to a predetermined operation standard from the corresponding multiple sub-modes.

In the embodiment of FIG. 2, the mode selection block 130 includes a micro controller unit (MCU) 234 and a firmware 236. The firmware 236 can store a computer-executable program. The MCU 234 can execute the computer-executable program in the firmware 236 to select the operating mode and/or sub-mode. The MCU 234 can read the mode data in the register 144 indicative of the operating modes and/or sub-modes in which the controller 140 can operate. The MCU 234 can issue an identification command (e.g., an Identify Device command if the storage medium 106 is a CF4 card) to detect the type of the storage medium 106 and the modes that the storage medium 106 can support. After selecting the operating mode and/or the operating sub-mode, the MCU 234 can issue a configuration command (e.g., a Set Feature command if the storage medium 106 is a CF4 card) to configure a register in the storage medium 106 to set the storage medium 106 in the selected operating mode and/or sub-mode, and can configure the register 144 to set the controller 240 in the selected operating mode and/or sub-mode by writing the mode data indicative of the selected operating mode and/or sub-mode in the register 144.

According to the operating mode selected by the mode selection block 130, the multiplexer 152 enables one of the PCMCIA core 246 and the True IDE core 248 according to the mode data indicative of the selected operating mode in the register 144. Thus, the enabled core can communicate with the storage medium 106 according to the corresponding data transfer rate in the selected operating mode and/or sub-modes. In another embodiment, a single core can selectively operate in the PCMCIA mode or the True IDE mode to communicate with the storage medium 106. Consequently, the data transfer between the host 102 and the storage medium 106 can be enabled.

Therefore, the controller 140 can control data transfer adapted to various storage medium 106 and in accordance with various operation standards. Furthermore, the storage medium 106 can communicate with host systems via the PCIe interface 120 having relatively high performance. As such, the performance of the data transfer can be further improved. Moreover, the controller 140 supports the hot plug since the PCIe interface 120 supports the hot plug.

In one embodiment, before the storage medium 106 is coupled to the controller 140, the controller 140 is set in a default mode. In one embodiment, the default mode can be the True IDE mode. After the storage medium 106 is coupled to the controller 140, the mode selection block 130 can issue an identification command (e.g., an Identify Device command if the storage medium 106 is a CF4 card) to the storage medium 106 to determine if the default mode is compatible with the storage medium 106. If the default mode is compatible with the storage medium 106, the MCU 234 can issue a configuration command (e.g., a Set Feature command if the storage medium 106 is a CF4 card) to set the storage medium 106 in the PCMCIA mode.

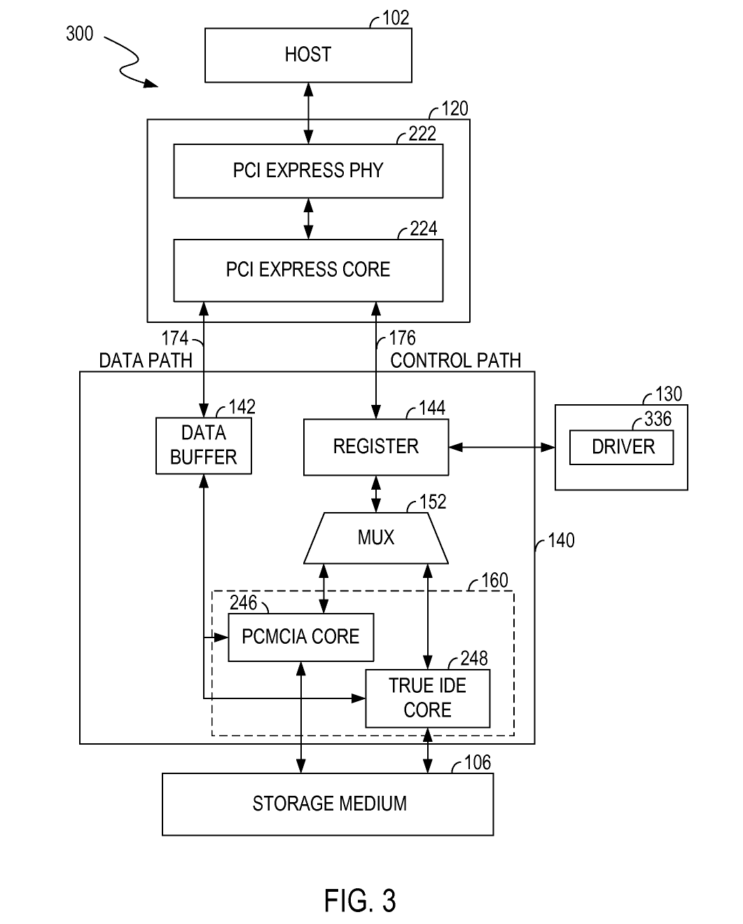

FIG. 3 shows a data transfer system 300 according to another embodiment of the present invention. Elements labeled the same as in FIG. 2 have similar functions.

In the embodiment of FIG. 3, the mode selection block 130 can be located outside the controller 140. The mode selection block 130 includes a driver 336, e.g., a computer-executed program for selecting the operating mode and the operating sub-mode. In one embodiment, a signal processor (not shown) of the host 102, for example, a central processing unit (CPU), can execute the driver 336 to perform the mode selection function.

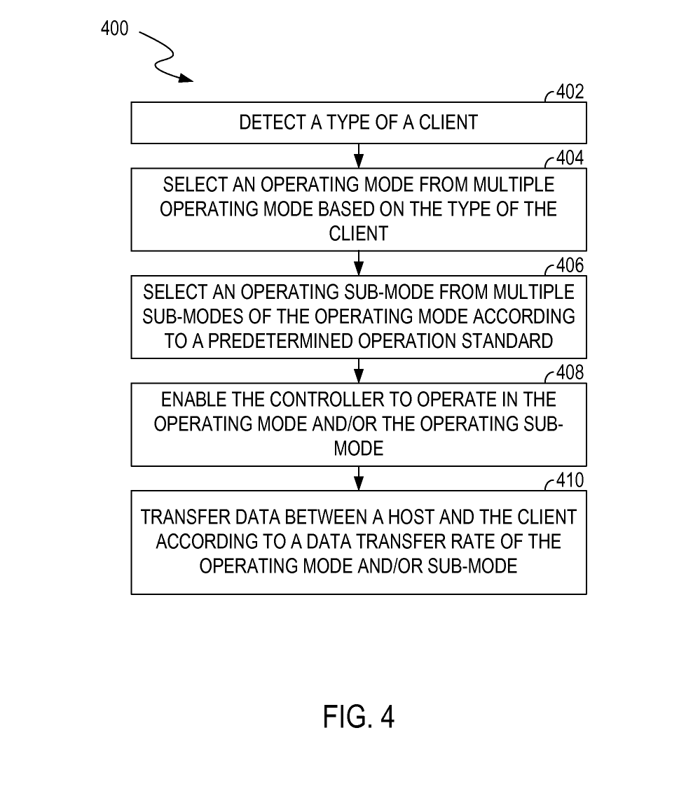

FIG. 4 shows a flowchart 400 of a method for controlling data transfer according to one embodiment of the present invention. FIG. 4 is described in combination with FIG. 1. Although specific steps are disclosed in FIG. 4, such steps are examples. That is, the present invention is well suited to performing various other steps or variations of the steps recited in FIG. 4. In one embodiment, the flowchart 400 is implemented as computer-executable instructions stored in a computer-readable medium.

In block 402, a type of the storage medium 106 and the mode(s) supported by the storage medium 106 can be detected. In block 404, an operating mode is selected from multiple operating modes based on the type of the storage medium 106. For example, the mode selection block 130 in the controller 140 can access the mode data stored in the register 144 indicative of multiple modes and sub-modes in which the controller 140 can operate. The mode selection block 130 selects an operating mode which is compatible with the storage medium 106 from the operating modes.

In block 406, an operating sub-mode is selected from multiple sub-modes according to a predetermined operation standard. In one embodiment, the selected operating mode may include multiple sub-modes. In this instance, the mode selection block 130 can further select the operating sub-mode from the corresponding sub-modes according to the predetermined operation standard, e.g., a data transfer rate standard or a priority standard.

In block 408, the controller 140 can be enabled in the operating mode and/or sub-mode. The mode selection block 130 can configure the register 144 to set the controller 140 in the operating mode and/or sub-mode. In one embodiment, the mode selection block 130 can write the mode data indicative of the selected operating mode and/or sub-mode in the register 144 to set the controller 140 in the selected operating mode and/or sub-mode.

In block 410, the controller 140 can transfer data between the storage medium 106 and the host 102 according a data transfer rate and a read/write timing cycle of the selected operating mode. According to the mode data that indicates the selected operating mode and/or sub-mode in the register 144, the multiplexer 152 can enable a core in the core block 160. As such, the enabled core can communicate with the storage medium 106 to exchange data with the storage medium 106 according to the data transfer rate and the read/write timing cycle of the selected operating mode.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. An electronic system, comprising:
an input/output (I/O) interface; and
a controller coupled to said I/O interface and a storage medium and operable for selecting an operating mode from a plurality of operating modes based on a type of said storage medium and for operating in said operating mode to transfer data between said I/O interface and said storage medium according to a data transfer rate of said operating mode,
wherein at least two of said operating modes have different data transfer rates.

2. The system of claim 1, wherein said at least two of said operating modes have different data read/write timing cycles, and wherein said controller transfers said data between said I/O interface and said storage medium according to a corresponding data read/write timing of said operating mode.

3. The system of claim 1, wherein said operating mode further comprises a plurality of sub-modes, and wherein said controller is further operable for selecting an operating sub-mode from said sub-modes based on a predetermined operation standard.

4. The system of claim 3, wherein said predetermined operation standard comprises a data transfer rate standard, and wherein said controller selects said operating sub-mode to obtain a desired data transfer rate of a data transfer between said I/O interface and said storage medium.

5. The system of claim 3, wherein said predetermined operation standard comprises a priority standard, and wherein said controller selects said operating sub-mode according to a priority of a data transfer request of a data transfer between said I/O interface and said storage medium.

6. The system of claim 1, wherein said operating modes comprise a PCMCIA (personal computer memory card memory card international association) mode and a True IDE (integrated development environment) mode.

7. The system of claim 1, wherein said controller comprises a register operable for storing mode data indicative of said operating modes of said controller.

8. The system of claim 7, wherein said controller further comprises a mode selection block configured to issue an identification command to said storage medium to identify said type of said storage medium, and configured to access said mode data to select said operating mode.

9. The system of claim 7, wherein said controller further comprises a multiplexer coupled to said register and operable for selecting a core from a plurality of cores according to said operating mode, wherein said selected core communicates with said storage medium according said data transfer rate.

10. The system of claim 1, wherein said interface comprises a Peripheral Component Interconnect Express (PCIe) interface.

11. The system of claim 1, wherein said storage medium is selected from the group consisting of a CompactFlash+ (CF+) card and a CompactFlash 4 (CF4) card.

12. A controller for controlling data transfer between a host and a client, said controller comprising:
a register operable for storing mode data indicative of a plurality of operating modes of said controller, wherein at least two of said operating modes have different data transfer rates;
a mode selection block operable for accessing said mode data and selecting an operating mode from said operating modes based on a type of said client; and
a plurality of cores coupled to said client, wherein a core of said cores is selected based on said operating mode to enable communication between said host and said client according to a data transfer rate of said operating mode.

13. The controller of claim 12, wherein said at least two of said operating modes have different data read/write timing cycles, and wherein said core enables said communication between said host and said client according to a corresponding data read/write timing of said operating mode.

14. The controller of claim 12, wherein said operating mode further comprises a plurality of sub-modes, and wherein said mode selection block is further operable for selecting an operating sub-mode from said sub-modes based on a predetermined operation standard.

15. The controller of claim 14, wherein said predetermined operation standard comprises a data transfer rate standard, and wherein said controller selects said operating sub-mode to obtain a desired data transfer rate of said data transfer.

16. The controller of claim 14, wherein said predetermined operation standard comprises a priority standard, and wherein said controller selects said operating sub-mode according to a priority of a data transfer request of said data transfer between said host and said client.

17. The controller of claim 12, wherein said operating modes comprise a PCMCIA (personal computer memory card memory card international association) mode and a True IDE (integrated development environment) mode.

18. The controller of claim 12, wherein said client comprises a storage medium.

19. The controller of claim 12, wherein said mode selection block comprises a micro controller unit operable for issuing an identification command to said client to identify said type of said client and for selecting said operating mode.

20. The controller of claim 19, wherein said micro controller unit issues a configuration command for configuring said register to set said controller in said operating mode.

21. A method for controlling data transfer between a host and a client, said method comprising:
detecting a type of said client;
selecting an operating mode from a plurality of operating modes based on said type of said client by a controller, wherein at least two of said operating modes have different data transfer rates;
enabling said controller to operate in said operating mode; and
transferring data between said host and said client according to a data transfer rate of said operating mode.

22. The method of claim 21, further comprising:
selecting an operating sub-mode from a plurality of sub-modes of said operating mode according to a predetermined operation standard.

23. The method of claim 22, wherein said predetermined operation standard comprises a data transfer rate standard, and wherein said controller selects said operating sub-mode to obtain a desired data transfer rate of said data transfer between said host and said client.

24. The method of claim 22, wherein said predetermined operation standard comprises a priority standard, and wherein said controller selects said operating sub-mode according to a priority of a data transfer request of said data transfer between said host and said client.

25. The method of claim 21, further comprising:
setting said controller in a default operating mode before said client is coupled to said controller.
